(19) United States
(12) Patent Application Publication
(10) Pub. No.: US 2013/0106873 A1
(43) Pub. Date: May 2, 2013

(54) PLUGGABLE MEDIA SOURCE AND SINK

(71) Applicants: Matthew Andrews, Redmond, WA (US); Kim-chyan Gan, Sammamish, WA (US); Shafiq Rahman, Redmond, WA (US); Glenn F. Evans, Kirland, WA (US)

(72) Inventors: Matthew Andrews, Redmond, WA (US); Kim-chyan Gan, Sammamish, WA (US); Shafiq Rahman, Redmond, WA (US); Glenn F. Evans, Kirland, WA (US)

(73) Assignee: Microsoft Corporation, Redmond, WA (US)

(21) Appl. No.: 13/284,653

(22) Filed: Oct. 28, 2011

(51) Int. Cl. G06F 13/14

(52) U.S. Cl. 345/520

(57) ABSTRACT

In a digital media pipeline, hardware-accelerated transform functions enable longer CPU idle time and a reduction in data transfer between the CPU and hardware, for the primary purpose of conserving power or increasing content security. Multiplexer/de-multiplexer functions can be configured as either stand-alone transform units or as plug-in components to a “pluggable” (host) media source or to a “pluggable” (host) media sink, so that the benefit of hardware acceleration can be applied to the source and sink as well as to the media foundation transform (MFT). Further data processing and control can be routed to a remote processing entity. The disclosed pluggable media source has a single input and one or more outputs; the pluggable media sink has one or more inputs and a single output. The pluggable media source and sink can be configured to accept plug-in components that support a wide range of data formats.

### BACKGROUND

Storage and playback of digital media (e.g., music, movies, streaming television, YouTube videos, and the like) can be enabled by a “framework” within which various modular data processing functions can be deployed. A media player is an example of a product that can be developed within such a framework. Some platform manufacturers encourage software developers to develop different software application components, or “plug-ins” to provide additional data processing functionality to a host program, such as a media player. Examples of well-known plug-ins for supporting Internet-based digital media include Adobe Flash Player™ and Quick Time™. The framework can also provide input/output (I/O) support, access to hardware, and integration with other parts of the system. A framework is typically operating system (OS)-specific. For example, Microsoft Media Foundation™ (MF) is a multimedia framework for developing digital media under the Windows Vista™ operating system.

Typically, a digital media framework supports a data “pipeline” capable of accepting digital audio and video data as input (“source”), subjecting the data to a data processing sequence (“transforms”), and outputting the data to a destination (“sink”). Examples of media sources include files, network servers, and camcorders. Examples of media sinks include storage devices, such as computer memory (“archive sinks”), or output devices, such as display screens (“rendering sinks”). A transform component performs processing tasks on a digital media data stream, such as, for example (a) controlling synchronization of audio and video signals to ensure that video is rendered on a display at the same time the corresponding audio is played through a loudspeaker; (b) receiving a high definition (HD) bit stream containing audio and video data, decoding the bit stream, and splitting the data into separate audio and video signals for presentation; or (c) splitting multiple audio streams into separate audio channels (for example, a movie soundtrack in two or more languages). A transform can also include encoding, decoding, effect (video stabilization), upsampling/downsampling, color conversion, multiplexing, or de-multiplexing.

Data processing functions can be implemented in software (e.g., as a stand-alone filter), offloaded for processing by hardware, or they can use a combination of software and hardware, in which the portion implemented in hardware generally offers a speed advantage, and is referred to as “hardware acceleration.” Some existing multimedia processing systems utilize hardware acceleration for data-intensive processing functions (i.e., transforms), such as video rendering to a display or video encoder/decoders (“codecs”) that convert data from one type to another. Codecs can be software-based or hardware-based. An example of a software-based codec is a piece of code that compresses or un-compresses a stream of video data and converts it to a different data type. An example of a hardware-based codec is a digital signal processing (DSP) device. Another example of a media transform is a multiplexer/de-multiplexer. Two or more data streams can be combined into a single bit stream using a multiplexer, or “MUX”; data splitting can be accomplished using a de-multiplexer, or “de-MUX.” Different data formats can require customized versions of MUXes and de-MUXes. Some data formats use multiple layers of multiplexing, such as ARIB, MPEG2-transport streams, and the like. Like codecs, MUX and de-MUX functions can be implemented in either software or hardware. Usually, media sinks and transforms are designed to handle data in a specific format.

Sometimes, digital rights management (DRM) policies and associated encryption and authentication mechanisms are applied to media content. Various components in the pipeline or the processing hardware may be trusted at different levels such that authentication and decryption keys are needed to access or interpret the bit stream.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The architecture disclosed provides modular MUX and de-MUX software functions within a digital media pipeline architecture, that are capable of being hardware-accelerated, (i.e., optionally replaceable at least in part by a hardware module), or processed by a remote hardware entity. Hardware acceleration avoids shuffling data and parsing control decisions back and forth between the CPU and hardware. Hardware acceleration can enable longer CPU idle time and transferring tasks to optimized computation units for the purpose of conserving power while streaming digital content. In addition, the MUX and de-MUX functions can be configured either as independent “stand-alone” transforms or as modular “plug-ins” accepted by a “pluggable” (host) media source or by a pluggable (host) media sink, so that the benefit of hardware acceleration can be applied to the source and sink as well as to the transform stage(s). The disclosed pluggable media source has a single input and one or more outputs; the pluggable media sink has one or more inputs and a single output.

By providing modular plug-in functionality along with a remote ‘logical’ connection scheme, data can flow directly from one hardware device to another without requiring intervention by the host CPU. Typically, a software MUX can create a bottleneck in the media pipeline. Offloading both the processing and control can reduce considerably the central processing unit (CPU) utilization of a media application, typically by 50% or more. Specifically, access to hardware acceleration for MUX and de-MUX functions can be beneficial in enabling speed enhancement during splitting as well as during coding/decoding of a streaming media pipeline. If codecs and MUX/de-MUX functions within a media pipeline are simultaneously hardware-accelerated, it can be possible for a CPU to shut off while streaming multimedia data, resulting in a considerable increase in battery life. Furthermore, when functions are hardware-accelerated by processing data remotely on another logical process, program, or computational entity other than on local hardware, there can be a security advantage. The remote process, because it is isolated, is inherently more tamper-proof, making it a more desirable option for DRM and security reasons.

The pluggable media source and sink described herein can be configured to accept plug-ins that support a wide range of data formats, such as, for example, the popular MPEG2 and its variants, in order to serve a large population of devices with high quality content. It is therefore desirable that the MUX and de-MUX architectures described herein support the MPEG2 format so these architectures can be used often in response to a media sink query for an MPEG2-compatible transform.

The MUX and de-MUX functions described herein are configured to operate “asynchronously,” i.e., these functions receive input data on request or when it is available, and they supply results as they are generated, rather than at fixed time intervals dictated by a system clock or other internal components. Thus, the rate at which the MUX and de-MUX components operate is not tied to other components within the pipeline, i.e., they operate independently. The MUX or de-MUX components can adjust data processing rates, based on availability of hardware cores for processing, access to the display, the system clock, or other factors.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram showing basic component blocks for a simplified digital media pipeline architecture.

FIG. 2A is a block diagram of an exemplary digital media pipeline architecture capable of using hardware acceleration to stream multimedia signals to a destination such as a file or a display.

FIG. 2B is a block diagram of an exemplary digital media pipeline architecture capable of using a remote process or entity to stream multimedia signals to a destination such as a file or a display.

FIG. 3 is a flow chart showing steps in a method of implementing a hardware-accelerated multi-media pipeline,

FIG. 4 is a block diagram of a generic pluggable media source, in which a de-MUX plug-in can be hardware-accelerated.

FIG. 5 is a block diagram of a stand-alone MUX transform in a simplified media pipeline, in which the transform can be hardware-accelerated.

FIG. 6 is a block diagram of a generic pluggable media sink, in which a MUX plug-in can be hardware-accelerated.

FIG. 7 is a flow diagram showing interactions between components of the media sink of FIG. 4 during sink initialization and shutdown.

FIG. 8 is a flow diagram showing interactions between various components of the media sink of FIG. 4 during sample processing.

FIG. 9 is a block diagram illustrating an example of a computing environment that can be used to implement any of the technologies described herein.

### DETAILED DESCRIPTION

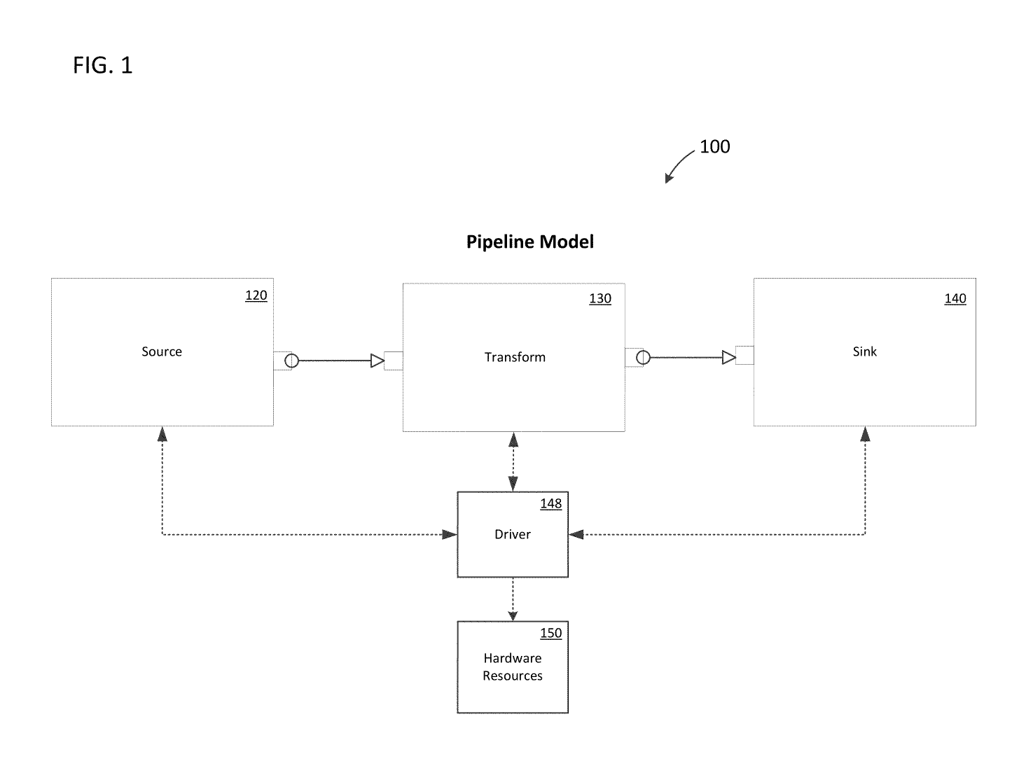

FIG. 1 shows a simplified, generic media pipeline software model 100 that includes three software modules: a source module 120, a transform unit 130 and a sink module 140. Using the pluggable pipeline architecture technology described herein, one or more of the source module 120, transform module 130, and sink module 140 can optionally be hardware accelerated by a specialized auxiliary processing core as indicated by dotted-line connections to a driver 148 and hardware resources 150. For example, a plugged-in modular driver 148, (available from various graphics card manufacturers) can be invoked by the source 120 for de-MUXing specific media formats (e.g., H.264).

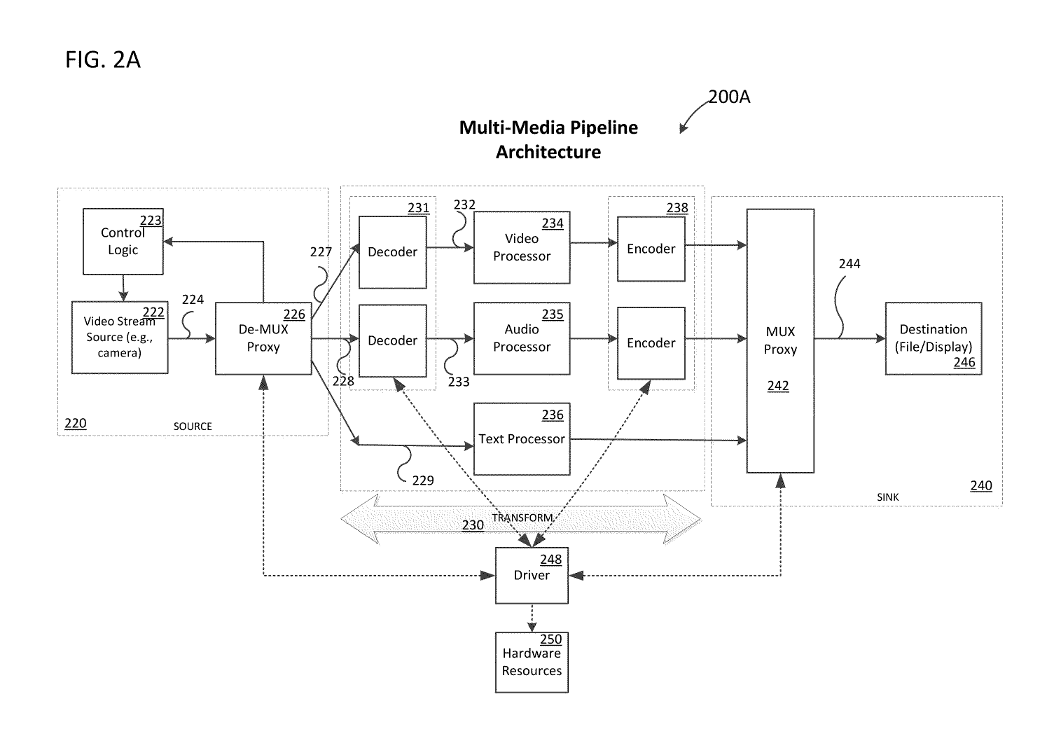

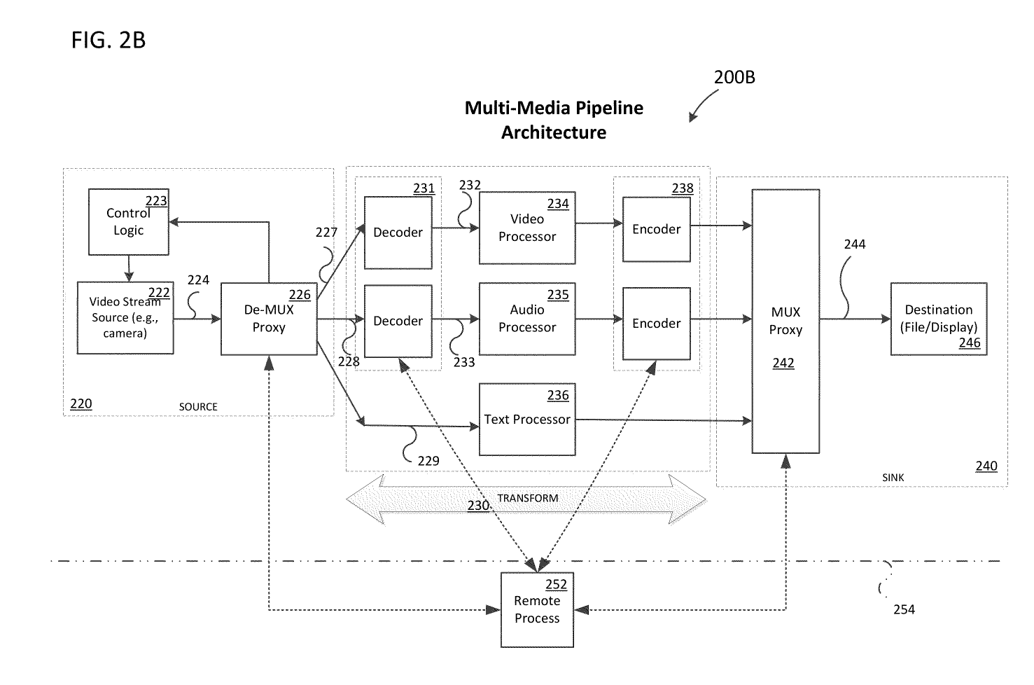

FIG. 2A shows a representative example of a digital multi-media pipeline architecture 200A presented as context for the techniques discussed herein. The media pipeline architecture 200A comprises a system that is generally capable of streaming multimedia information from a video stream source 222 to a destination 246. An example of a video stream source 222 is image and sound information captured by a live video camera, webcam, other live broadcast media, streaming media, or a video attachment to an e-mail. Exemplary destinations include a display screen, or a computer memory for storing data (e.g., in a file) for rendering to a display at a later time.

The basic stages in the pipeline architecture 200A, include a source 220, a transform 230, and a sink 240, corresponding to those shown in FIG. 1, which are implemented here as software modules (shown within dashed lines). Each of the software modules 220-240 can be optionally hardware accelerated using a graphics driver 248 in conjunction with hardware resources 250 (e.g., a low-power multi-media graphics processing unit (GPU) hardware chip, or other, possibly dedicated, media processing hardware, shown outside the dashed lines). Exemplary elements of the pipeline architecture 200 include codecs 231 and 238, de-MUX proxy/MUX transform units 226 and 242, and a set of media processors including a video processor 234, an audio processor 235, and a text processor 236. The graphics driver 248 and GPU or other media processing hardware examples shown as attachments to the MUX 242 can also be attached to the de-MUX proxy 226 and to the codecs 231 and 238, to achieve full hardware acceleration, wherein the entire pipeline is capable of being hardware-accelerated so that the CPU can be idle while the hardware-accelerated pipeline is running.

With reference to the pipeline architecture 200A, the video stream source 222 can be configured to produce a byte stream 224 that contains one or more data types, such as raw images, sound, and text. The byte stream 224 can be split into these separate data types by a de-MUX proxy 226 so that data processing can then occur separately on each data type. Data and control signals generated by control logic 223 can be optionally fed back to affect the parsing or selection of the source content. The resulting video and audio data streams 227 and 228 can be coded and/or compressed by a first set of codecs (decoders) 231, such that the video data 227 is converted into an encoded video data stream 232 having a standard video format such as MPEG2, and the audio data 228 is converted into an encoded audio data stream 233 having a standard audio format such as WAV or MP3, for example. The encoded video and audio data streams 232 and 233 can then be processed separately by the video processor 234, and the audio processor, 235, respectively. The text data 229 can also be provided and processed by the text processor 236 for use as subtitles accompanying the audio track. The data streams can then be converted by a second set of codecs (encoders) 238, and re-combined by the MUX 242 into an output byte stream 244. Data represented by the output byte stream 244 can be hard-wired or transmitted by a wireless service for presentation at the destination 246.

In a typical media pipeline architecture 200, the codecs, MUX, de-MUX, and data processing functions can be categorized as types of transforms, while the video stream source 222 is a type of generic source 220 and the destination 246 is a type of generic sink 240. However, in the implementations below, the de-multiplexer and multiplexer functions can also be deployed as specialized, hardware-accelerated, plug-in components inside the source and sink stages in the pipeline. The media pipeline 200, when configured with these specialized components as described herein, constitutes a modular (“pluggable”) architecture, having a modular (“pluggable”) media source 220, a media transform unit 230, and a modular (“pluggable”) media sink, 240, each of which is designed to have a well-defined standard interface. In previous implementations, media sinks have had internal MUXes such that the sink was format-specific, whereas the pluggable media sink 240 generically handles multiple formats, thereby simplifying development of plug-ins.

Different exemplary applications of the media pipeline architecture 200 can use parts or all of the components shown in FIG. 2. For example, a) a video stream source 222 in the form of a video attachment to an e-mail may utilize the de-MUX proxy 226 and the decoders 231 before sending raw video and sound data to present at the destination 246. Thus, the processors 234-236 and the encoders 238 may not be needed in such an application. In another example, b) raw video and sound signals may be provided to a movie-editing application which would then utilize the encoders 238 and the MUX 242 to create a file 246 that can be transmitted via e-mail. In such an application, the de-MUX proxy 226, decoders 231, and processors 234-236 may not be needed. In another example, c) a transcoder application that changes the resolution of multi-media signals may use all of the components shown in the pipeline architecture 200, including the de-MUX proxy 226, the decoders 231, the processors 234-236, the encoders 238, and the MUX 242.

FIG. 2B shows another embodiment of a media pipeline architecture, 200B, similar to 200A, in which another logical program or remote process 252, separated from the pipeline architecture 200 by a process boundary 254, can be substituted for the hardware resources 250 and the driver 248. In either embodiment 200A or 200B, secure channels associated with DRM keys or authentication mechanisms can be routed to the hardware resources, or the remote process, respectively.

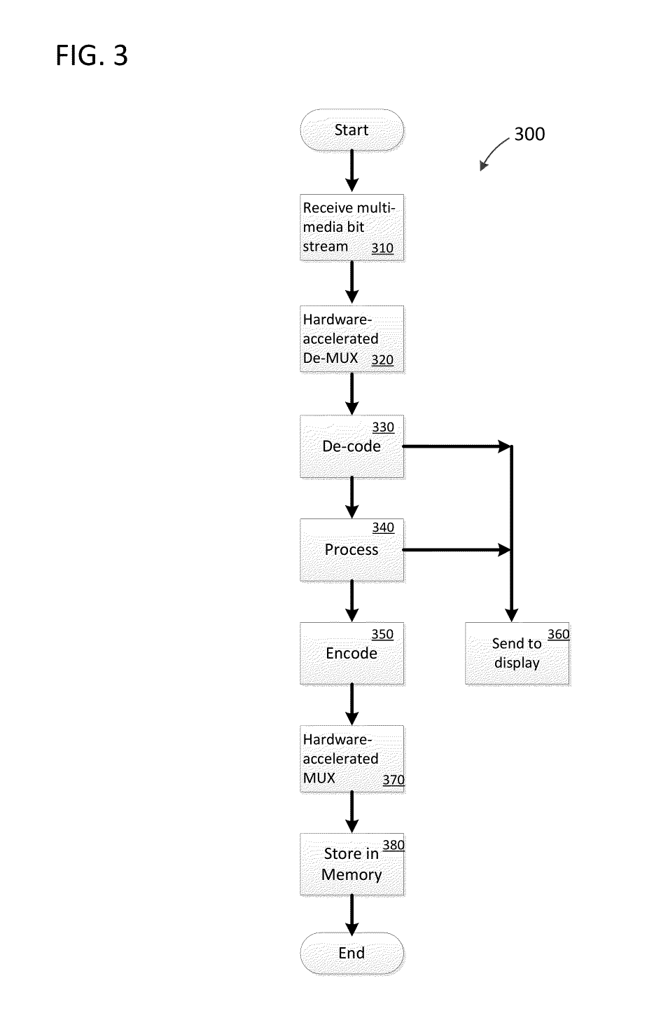

FIG. 3 illustrates a method 300 of implementing a hardware-accelerated multi-media pipeline such as the pipeline architecture shown in FIG. 2. This method could be used, for example, by a server to transcode multimedia content from one resolution to another. In step 310, a multi-media bit stream 224 is received. Different media signals comprising the multi-media bit stream 224 are de-multiplexed 320 by a hardware-accelerated de-MUX transform unit. The resulting separate data signals 227, 228, and 229 are then decoded 330 (e.g., uncompressed), and processed 340, at which point the signals can be sent to a display 360. Or, the raw signals may be re-encoded 350 (e.g., compressed at a different resolution than the original bit stream 224). Once the signals are combined by a hardware-accelerated MUX 242, they can be stored 380 in a memory destination 246. The method 300 utilizes a hardware driver configured to perform one or more steps, wherein the driver is programmed to access hardware resources via an application program interface (API) to perform functions such as encoding/decoding, and multiplexing/de-multiplexing that otherwise can be performed by software.

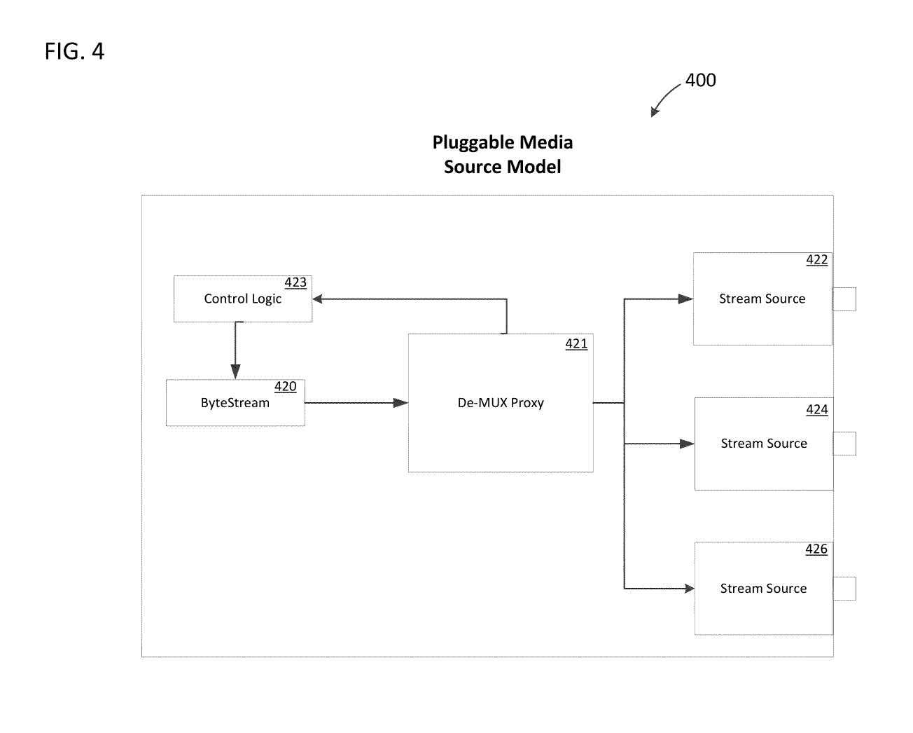

The generic models shown in FIGS. 4-6 are abstracted representations that correspond to portions of the exemplary pipeline architecture shown in FIG. 2. FIG. 4 shows a generic pluggable media source model 400, which can be configured to support one or more multimedia stream container formats, such as, for example, MPEG2 and MPEG4. Media source model 400 is implemented with a specialized de-MUX transform 421 configured as a plug-in component that offers the benefit of hardware acceleration to improve efficiency of the media source. The de-MUX transform 421 can be used to split a single input byte stream 420 into multiple source outputs, for example, a first stream source 422 and a second stream source 424. In an exemplary embodiment similar to that shown in FIG. 2, the first stream source 422 can be an audio stream, such as a movie soundtrack, or multiple audio streams, while the second stream source 424 can be a video stream, such as a sequence of movie frames. The media source model 400 can also comprise additional source streams 426, including for example, subtitle streams containing text in different languages, that can be subsequently selected and combined with the audio stream and video stream. According to an alternative embodiment, the de-MUX transform 421 can be configured as a stand-alone filter instead of as a plug-in component. Stream data and control signals can be fed back into a control logic unit 423 for influencing the byte stream source. For example, some container formats such as MPEG2-Transport streams include configuration tables for dynamically configuring the parsing process or retrieval of source data. This may also involve logic to negotiate DRM keys and authentication with the byte stream.

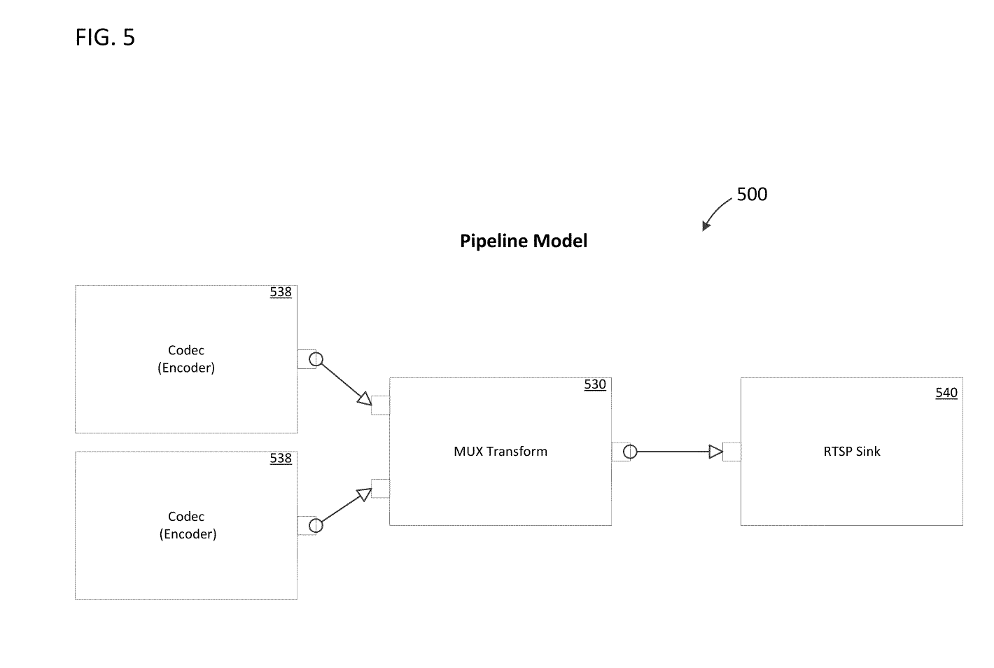

FIG. 5 depicts an exemplary scenario in which a simplified digital media pipeline model 500 can be implemented using a specialized, stand-alone, asynchronous MUX transform unit 530. The MUX transform unit 530 can be used directly inside the media processor to accept multiple input streams. Generally, the number of input streams is variable, and input streams can be dynamically added to the MUX transform unit 530. Using the MUX transform unit 530, data streams from first and second encoders 538 can be combined into a single output, such as Real Time Streaming Protocol (RTSP) sink 540. In this representative example, the MUX transform unit 530 is followed within the pipeline by the RTSP sink 540, which can place data into one or more RTP payloads. Alternatively, instead of using the MUX transform unit 530 as a stand-alone transform, it can be deployed as a modular asynchronous plug-in component to the RTSP sink 540, which can then output data to a destination, such as an output file. Thus, because it is modular, the MUX can be deployed as either a stand-alone transform, or a plug-in component to a sink.

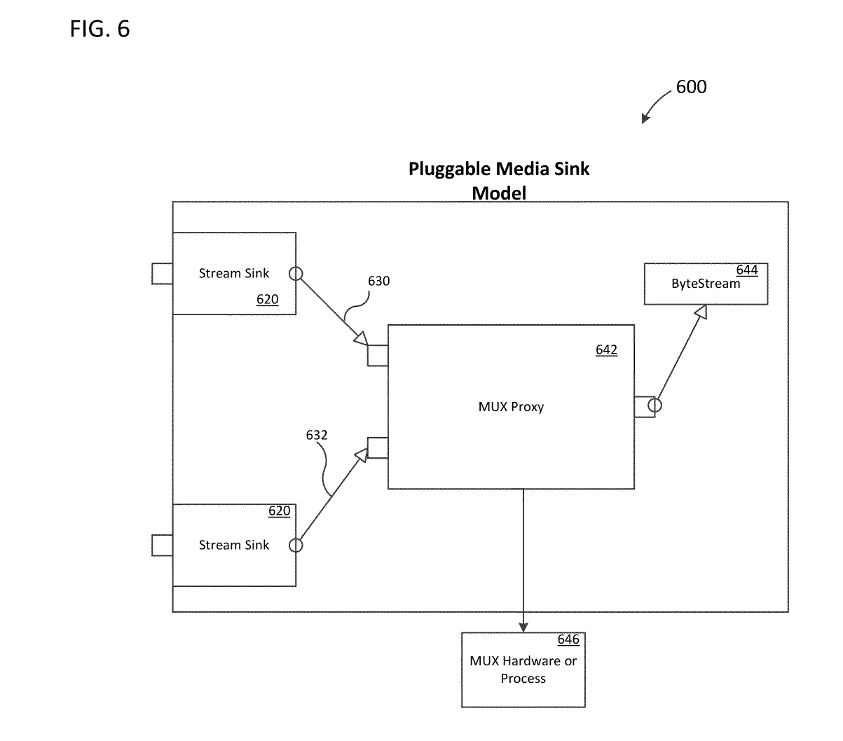

FIG. 6 shows a generic pluggable media sink implementation, or media sink model 600, which can be configured to support one or more data formats, such as, for example, MPEG2. The media sink model 600 can be thought of as the opposite of the source model 100. The media sink model 600 is implemented using a specialized MUX plug-in component 642 that offers the benefit of hardware acceleration to improve efficiency of the media sink. The MUX proxy plug-in component 642 can be used to accept multiple inputs, such as stream sinks 620, and combine them into a single output, such as a byte stream 644. The MUX proxy component 642 routes the data and command control to the hardware or remote process entity 646 that performs the processing operations. The media sink implementation 600 desirably supports additional stream sinks 620, each of which corresponds to an additional input stream 630, 632 to the MUX plug-in component 642. Input requests for the stream sinks 620 are generated in response to input requests on the associated input stream of the MUX plug-in component 642. When the MUX plug-in component 642 generates output, an output sample is written to the sink's byte stream 644. In the context of the exemplary system shown in FIG. 2, the MUX plug-in component 642 can interleave an audio stream 630 with a video stream 632 for simultaneous playback. The MUX plug-in component 642 is capable of interleaving the audio and video input streams 630 and 632, respectively, e.g., within a bounded time interval of each other in the output stream to avoid degradation of playback performance.

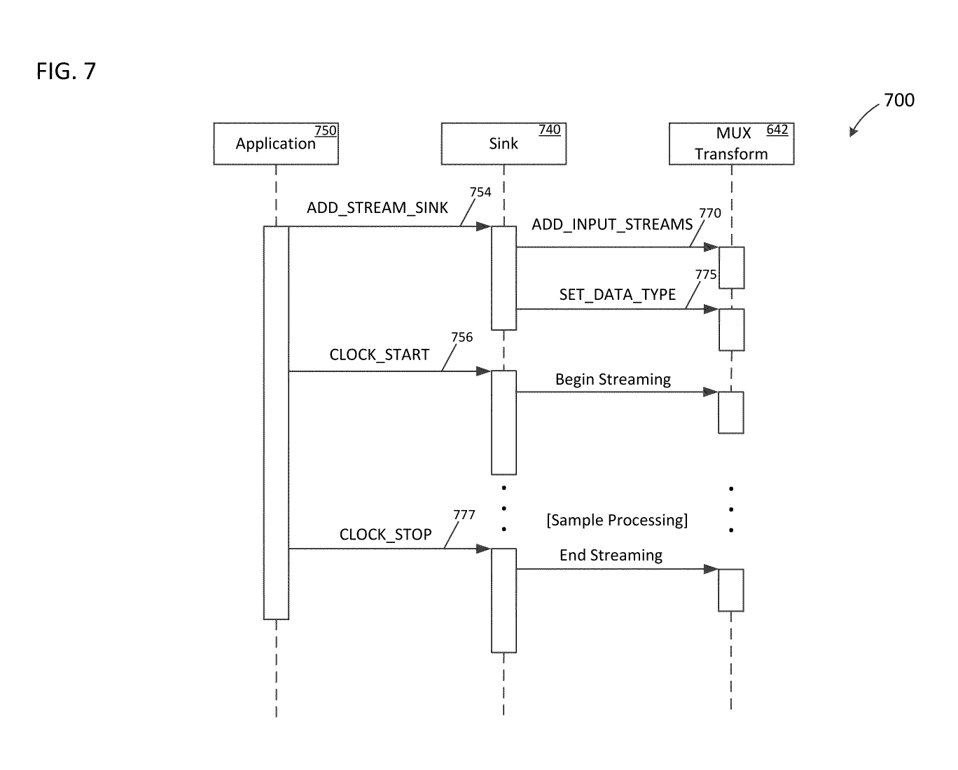

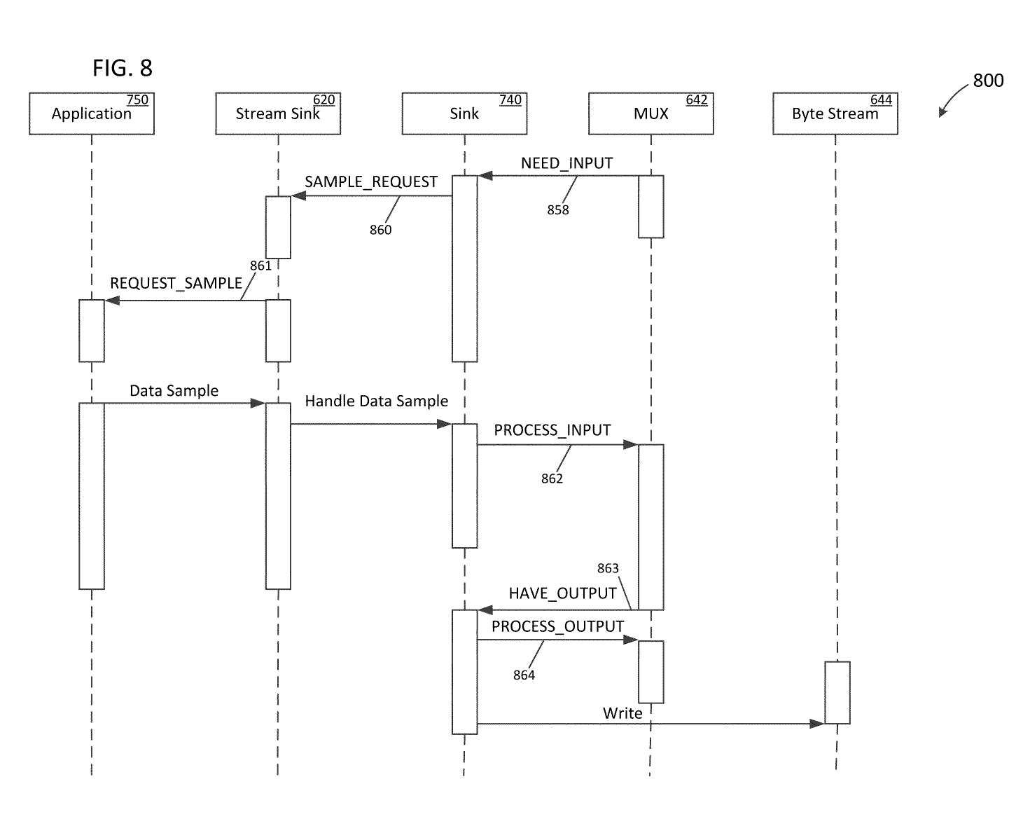

With reference to FIGS. 6-7, an exemplary program sequence 700 demonstrates detailed operation of the media sink model 600 of FIG. 6 during sink initialization and shutdown (FIG. 7). Detailed operation of the media sink model 600 during sample processing is detailed below in FIG. 8. The media sink model 600 includes three main software components: a media sink component 740, a variable number of stream sink components 620, and the MUX plug-in transform unit 642. In the exemplary program sequence 700, the media sink component 740 is initialized in response to a client application program 750 sending an ADD_STREAM_SINK command 754 for each input stream (e.g., 630, 632) that the client wishes to combine into an MPEG2 output container. Upon initialization, the sink component 740 is configured to dynamically create a stream sink 620 and a corresponding new input stream, (e.g., 630) to the MUX plug-in transform unit 642. A SET_DATA_TYPE command 775 is issued to set the media data type on the MUX plug-in transform unit 642 so as to include a major data type (e.g., “Transport” or “Program”) corresponding to the container type (e.g., MPEG2) of the desired output file, and a series of attributes to specify modifications or extensions to the data format. Based on the major data type, the MUX plug-in transform unit 642 is initialized to generate a program stream or a transport stream. Attributes can include, for example, “MPEG2_TIMECODE” for appending a time code to the front of each transport packet, and “MPEG2_CONTENT_PACKET” for appending a header to the beginning of each transport packet at 200-1000 ms intervals. Once the input streams 630, 632 are added 770 and a data type is assigned 775, the MUX plug-in transform unit 642 can add data to stream headers for each additional input stream. For example, in an MPEG2 implementation, the MUX plug-in transform unit 642 can add a new program for each new input stream, and a program association table packet can then be generated in response to each additional input stream. If multiple consecutive input streams are added, the program association table changes are desirably batched into a single packet. Upon receipt of a CLOCK_START command 756 from the application program 750, the sink 740 can instruct the MUX plug-in transform unit 642 to begin data streaming by forwarding transport packets of data to the output byte stream 644 according to the sequence described in FIG. 8.

With reference to FIG. 8, an exemplary program sequence 800 demonstrates detailed operation of the media sink model 600 of FIG. 6 during sample processing. Once the clock is running, the MUX plug-in transform unit 642 can begin generating a queue of NEED_INPUT events 858 to obtain data packets. Upon receipt of a NEED_INPUT event 858, the sink 740 checks to see if there is more than one data sample in an output process queue associated with MUX plug-in transform unit 642. If the output process queue contains one or zero samples, the sink 740 sends a SAMPLE_REQUEST 860 to the stream sink 620, and the stream sink 620 in turn queues a REQUEST_SAMPLE event 861 to request a sample from the client application program 750. When the client has a sample available and has received a sample request, the client is configured to process the sample by sending a data sample to the stream sink 620. In turn, the stream sink 620 passes the data sample to the sink 740, and the sink 740 sends a PROCESS_INPUT command 862 to the MUX plug-in component 642. The MUX plug-in transform unit 642 then multiplexes the input sample into the desired file output container format (e.g., .avi or .mkv). As long as more than one data sample is already queued for output to the byte stream 644, the sink 740 increments an input sample request counter and continues streaming data to the MUX plug-in transform unit 642. The MUX plug-in transform unit 642 utilizes a core MUX to do the actual byte stream formation and supply the MUX plug-in transform unit 642 with transport packets. The MUX can then package as many transport packets into a single output sample as possible, but desirably the number of buffered packets is limited to less than one second of media data.

When samples are ready for output to the output byte stream 644, the MUX plug-in transform unit 642 queues a HAVE_OUTPUT event 863 to the sink 740. The sink 740 then returns a PROCESS_OUTPUT command 864 to trigger receipt of the data sample from the MUX plug-in transform unit 642. The MUX desirably puts as many data packets as possible into a single output sample. The sink 740 then writes the sample data to the output byte stream 644. When the write operation is complete, the sink 740 checks to see if there are pending input requests that can be forwarded to the stream sink(s) 620. With reference to FIG. 7, when the client application program 750 sends a CLOCK_STOP command 777, the sink instructs the MUX plug-in transform unit 642 to stop writing data to the output byte stream 644 and the sequence 700 shuts down.

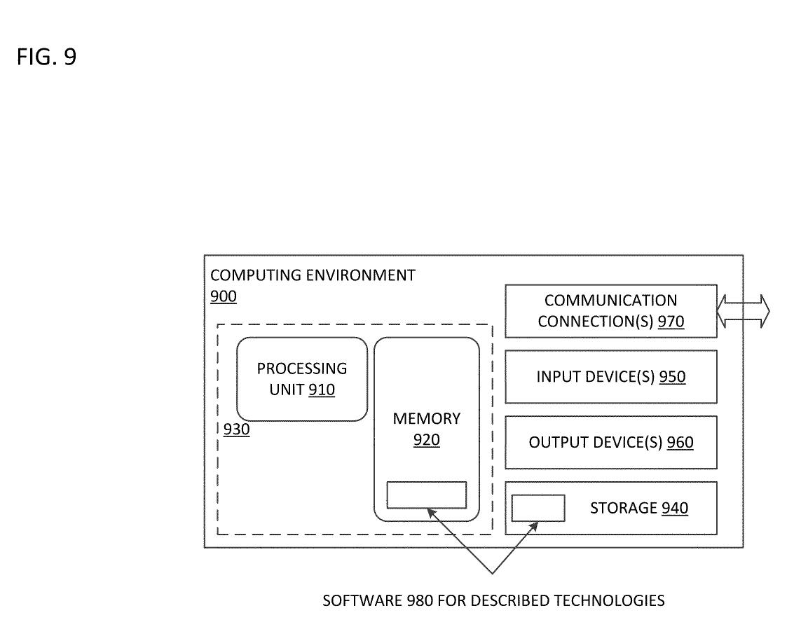

FIG. 9 illustrates a generalized example of a suitable computing environment 900 in which described embodiments, techniques, and technologies can be implemented. The computing environment 900 is not intended to suggest any limitation as to scope of use or functionality of the technology, as the technology can be implemented in diverse general-purpose or special-purpose computing environments. For example, the disclosed technology can be implemented with other computer system configurations, including hand held devices, multiprocessor systems, microprocessor-based or programmable consumer electronics, network PCs, minicomputers, mainframe computers, and the like. The disclosed technology can also be practiced in distributed computing environments where tasks are performed by remote processing devices that are linked through a communications network. In a distributed computing environment, program modules can be located in both local and remote memory storage devices.

With reference to FIG. 9, the computing environment 900 includes at least one central processing unit 910 and memory 920. In FIG. 9 this most basic configuration 930 is included within a dashed line. The central processing unit 910 can be configured to execute computer-executable instructions as either a real or a virtual processor. In a multi-processing system, multiple processing units execute computer-executable instructions to increase processing power and as such, multiple processors can be running simultaneously. The memory 920 can be a volatile memory (e.g., registers, cache, RAM), a non-volatile memory (e.g., ROM, EEPROM, flash memory), or some combination of the two. The memory 920 can be configured to store software 980 that can, for example, implement the technologies described herein. A suitable computing environment can have additional features. For example, the computing environment 900 includes storage 940, one or more input devices 950, one or more output devices 960, and one or more communication connections 970. An interconnection mechanism (not shown), such as a bus, a controller, or a network, can be configured to interconnect the components of the computing environment 900. Typically, an operating system (not shown) provides an operating environment for other software executing in the computing environment 900, and the operating system software is configured to coordinate activities of the components of the computing environment 900.

The storage 940 can be removable or non-removable, and includes magnetic disks, magnetic tapes or cassettes, CD-ROMs, CD-RWs, DVDs, or any other medium which can be used to store information and which can be accessed within the computing environment 900. The storage 940 stores instructions for the software 980, which can implement technologies described herein.

The input device(s) 950 can be a touch input device, such as a keyboard, keypad, mouse, pen, or trackball, a voice input device, a scanning device, or another device, that provides input to the computing environment 900. For audio, the input device(s) 950 can be a sound card or similar device that accepts audio input in analog or digital form, or a CD-ROM reader that provides audio samples to the computing environment 900. The output device(s) 960 can be a display, printer, speaker, CD-writer, or another device that provides output from the computing environment 900. Exemplary output devices for display include televisions, cinematic displays, computers, mobile phones, tablet computers, electronic readers, and electronic billboards.

The communication connection(s) 970 enable communication over a communication medium (e.g., a connecting network) to another computing entity. The communication medium conveys information, such as computer-executable instructions, compressed graphics information, or other data in a modulated data signal.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention can be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A digital media pipeline architecture, comprising:
a modular media source having a standard interface that accepts a first plug-in component configured to receive a single data stream as input and to produce one or more outputs;
a modular media sink having a standard interface that accepts a second plug-in component configured to receive one or more data streams as input and to produce a single output of multimedia content to a destination; and
a media transform unit having a standard interface that connects to the media source and the media sink, the transform unit configured to process a data stream;
wherein the source, sink, and transform unit are implemented as software components that are each capable of being hardware-accelerated.

2. The pipeline architecture of claim 1, wherein the first plug-in component is a de-multiplexer and the second plug-in component is a multiplexer.

3. The pipeline architecture of claim 1, wherein the transform unit is a multiplexer.

4. The pipeline architecture of claim 1, wherein a multiplexer can be deployed as either the second plug-in component or the transform unit, or both.

5. The pipeline architecture of claim 1, wherein the destination is a file.

6. The pipeline architecture of claim 1, wherein the destination is a display.

7. The pipeline architecture of claim 1, wherein secure channels are routed to a hardware acceleration unit or a remote process.

8. The pipeline architecture of claim 1, wherein the number of inputs to the second plug-in component is variable and input streams are dynamically added to the media sink.

9. The pipeline architecture of claim 1, wherein the number of inputs to the media transform unit is variable and input streams are dynamically added to the transform unit.

10. The pipeline architecture of claim 1, wherein the media transform unit comprises a multiplexer plug-in component that acts as a proxy for hardware accelerating multiplexer functions.

11. The pipeline architecture of claim 10, wherein the multiplexer plug-in component is configured to operate as part of a media sink.

12. The pipeline architecture of claim 11, wherein the media sink is hardware-accelerated by a driver that accesses hardware resources.

13. The pipeline architecture of claim 12, wherein the driver is a graphics card driver and hardware resources comprise a graphics processing unit (GPU).

14. The pipeline architecture of claim 1, wherein the media transform unit comprises a multiplexer plug-in component that proxies the multiplexer functionality to a remote process.

15. A method implementing a hardware-accelerated multi-media pipeline, the method comprising:
receiving an input multi-media bit stream having at least an audio component and a video component;
using hardware acceleration, de-multiplexing the bit stream to separate the bit stream into component signals, the component signals comprising the audio component and the video component;
decoding the component signals to produce a decoded video signal and a decoded audio signal; and
outputting the decoded video and audio signals.

16. The method of claim 15, wherein the hardware acceleration is performed by a driver that accesses hardware resources.

17. The method of claim 16, wherein the driver is a graphics card driver and hardware resources comprise a graphics processing unit (GPU).

18. The method of claim 15, wherein the outputting comprises
displaying the decoded video signal by the client device; and
playing the decoded audio signal by the client device.

19. A method implementing a hardware-accelerated multi-media pipeline, the method comprising:
receiving multi-media component stream signals;
using hardware acceleration, multiplexing the stream signals into a byte stream; and
storing the byte stream.

20. The method of claim 19, wherein the multiplexing is hardware accelerated by a graphics card driver that accesses hardware resources comprising a graphics processing unit (GPU).
